(19) United States
(12) Patent Application Publication
(10) Pub. No.: US 2004/0071918 A1
(43) Pub. Date: Apr. 15, 2004

(54) Adhesive release film used in conjunction with adhesive backed material for attaching an object to a surface

(76) Inventor: Eli Cohen, Lincoln Park, NJ (US)

Correspondence Address: HOFFMAN, WASSON & GITLER, P.C., Suite 522, 2361 Jefferson Davis Highway, Arlington, VA, 22202, US

(21) Appl. No.: 10/679,364

(22) Filed: Oct. 7, 2003

Related U.S. Application Data
(60) Provisional application No. 60/416,757, filed on Oct. 7, 2002.

(51) Int. Cl. B32B 9/00

(52) U.S. Cl. 428/40.1

(57) ABSTRACT

An article for affixing an object to a surface such as wall or the human skin including a release film folded over itself and attached to an adhesive layer associated with the object. The release film would include a projection tab extending beyond the adhesive layer of the article and the edge of the article being attached, thereby facilitating the removal of the release tape in a manner allowing the object to be easily and accurately to the surface.

This application claims the benefit of provisional patent application No. 60/416,757, filed on Oct. 7, 2002.

### BACKGROUND OF THE INVENTION

1. Field of the Invention

The present invention relates to single faced or double faced adhesive tape used to secure an object to a surface.

2. Description of the Prior Art

Many adhesives are covered with a protective release paper or film to prevent the adhesive from prematurely sticking to a surface. The adhesive is secured to an object which is in turn attached to the surface. This surface could be relatively planar such as a wall or non-planar such as applying a bandage to a body part. Generally speaking, the adhesive can be affixed to the object at the factory, such as during the manufacture of the bandage, or the adhesive can be applied to the object directly by the consumer such as when a picture frame is secured to a wall. In either of these situations, adjusting the position of the object once the adhesive comes into contact with the surface is very difficult.

Prior art devices would include one release film in the case of a single-adhesive surface or two release films when utilized with a double-faced adhesive surface. These release films are normally pulled away from the adhesive surface just prior to the object being stuck in place. These objects could include the aforementioned picture frames and bandages as well as hooks, throw rugs, tiles, mirrors, house numbers, signs or the like.

In the case of objects, such as hooks, house numbers, or bandages, the object is manufactured with a single-faced adhesive surface covered by a single release film. This film is removed from the adhesive surface immediately prior to the object being affixed to a surface such as a body part or the wall. Double-face adhesive tape is generally available in roll form, or in precut pieces. Two release films are utilized with this type of double-face adhesive tape. One release film is removed from one side of the adhesive and the second release film is then removed from the remaining adhesive face just prior to affixing the object to a wall or other surface.

In both instances, problems frequently arise in precisely positioning the object to be attached to the surface. This is due to the fact that once the final release film is removed and the object is inaccurately positioned, it is quite difficult to reposition the object. This is true whether the object is to be permanently or semi-permanently adhered to a wall or floor surface or whether the article is to be applied to a portion of the human body.

Several United States patents have issued directed to the field of applying tapes or other objects to a particular surface. These patents include U.S. Pat. No. 5,141,793 issued to Fontanilla; U.S. Pat. No. 5,007,464 issued to Hermaski et al; U.S. Pat. No. 6,001,471 issued to Bries et al and U.S. Pat. No. 6,281,795 issued to Smith et al.

The patent to Fontanilla describes a pressure sensitive tape construction for a pipe insulation system applied to the split of an insulation tube such that the insulation can be secured in a closed position. A pressure sensitive tape 22 is utilized to provide a resealable temporary closure of the insulation 10 and permanent sealing upon installation of insulation 10 on a pipe 12. The tape includes an intermediate release liner 24 having a longitudinal edge 26 extending beyond the edge of the tape construction 22 to permit a user to separate the tape construction 22 for opening and closing the insulation 10. The liner 24 carries a layer of cohesive material 28 having low-adhesion properties for repeated temporary closure. As can be seen, the pressure tape of the Fontanilla patent along with the immediate release liner 24 would be used to repeatedly open and close the insulation 10 over the pipe 12. This particular configuration could not be used to properly position an object prior to the object being adhered to a relatively planar surface or to the body of an individual.

The patent to Hermaski et al illustrates an article support adapted for adhering to a substrate. A handle 22 is applied to a stretch release adhesive tape 20 initially attached to a base member 30. The purpose of the handle 22 is to remove the base member 30 from the stretch release adhesive tape 20 through the use of the handle 22. The teachings of the Hermaski et al patent would not be applicable to precisely affixing an object to a surface.

The patent to Bries et al describes a removable adhesive tape with a controlled sequential release. An object, such as a hook 42, is mounted on a wall 44 through the use of an adhesive tape including adhesive layers 14 and 16 separated by a tab portion 26. Liners 18 and 20 are used to protect the adhesive layers 14 and 16. Liner 20 is removed and the hook 42 is placed onto the adhesive layer 16. Similarly, liner 18 is removed and the hook 42 is attached to the wall 44 through the adhesive layer 14. The tab 26, while extending from the body of the adhesive layers is merely used to remove the hook from the wall.

The patent to Smith et al shows a label attached to the exterior of a package. The label includes a release layer 23 allowing an adhesive layer 22 to be attached to the package. It is noted that the release layer 23 does not extend beyond the edge of the adhesive layer 22.

A review of the aforementioned patents fails to describe a device for easily and accurately attaching an object to a surface without the necessity of constantly repositioning that article.

Therefore, it is an object of the present invention to develop an article used with a single face adhesive surface for easily attaching an object to a particular surface.

Still another object of the present invention would be to develop an article having double-faced adhesive surfaces for attaching an object to a surface.

### SUMMARY OF THE INVENTION

The present invention overcomes the deficiencies of the prior art by providing an article for precisely positioning an object on a surface. The article would be provided with either a single-faced adhesive surface or double-faced adhesive surfaces to be attached to an object which in turn is easily and accurately attached to the surface. The article would be provided with one or more folded release films initially adhering to an adhesive layer provided on the article. The article is then attached to an object either during the manufacturing process or directly by the consumer. Once the article is in place on the object, the object is pressed against the surface to which the object is to adhere and the release film is removed while the object is being pressed against the surface. One end of the release strip is folded at an angle of equal to or less than 180° and would adhere to one surface of the adhesive layer with the second end of the release film extending beyond the adhesive layer in the form of a tab to facilitate the removal of the release film during application of the object to the surface.

According to the teachings of the present invention, the object to be attached is first placed in its precise position and then fixed in place while the release film is removed. This is in contradistinction to the prior art. This invention permits the removal of the release film after, rather than before, the final placement of the object.

### BRIEF DESCRIPTION OF THE DRAWINGS

Further objects and advantages of the present invention can be found in the following detailed description of the preferred embodiments of the present invention when taken in conjunction with the accompanying drawings in which:

FIG. 1 is perspective view of a double-faced tape utilizing the teachings of the present invention;

FIG. 2 is a perspective view of the present invention used with a bandage;

FIG. 3 is a perspective view of the teachings of the present invention used to affix a picture or sign to a wall;

FIG. 4 is a perspective view showing a pointed adhesive shape designed to facilitate the removal of the release film; and

FIG. 5 is a perspective view showing the use of the release strip as it is removed from an adhesive used with a sign, a carpet or a tile.

### DETAILED DESCRIPTION OF THE PRESENT INVENTION

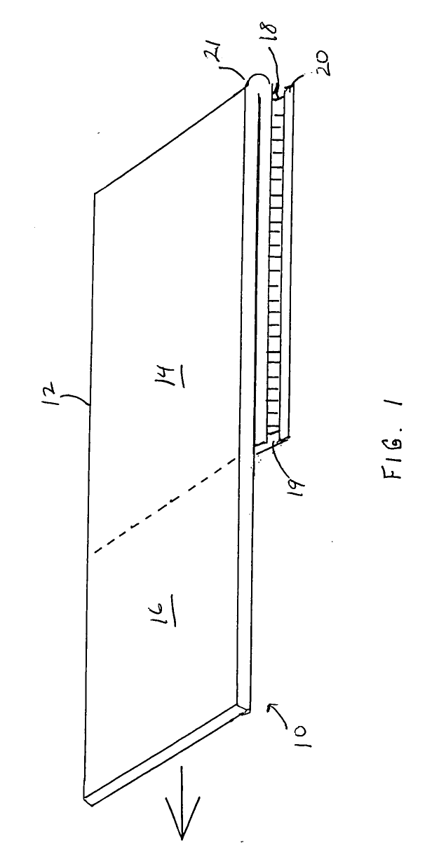

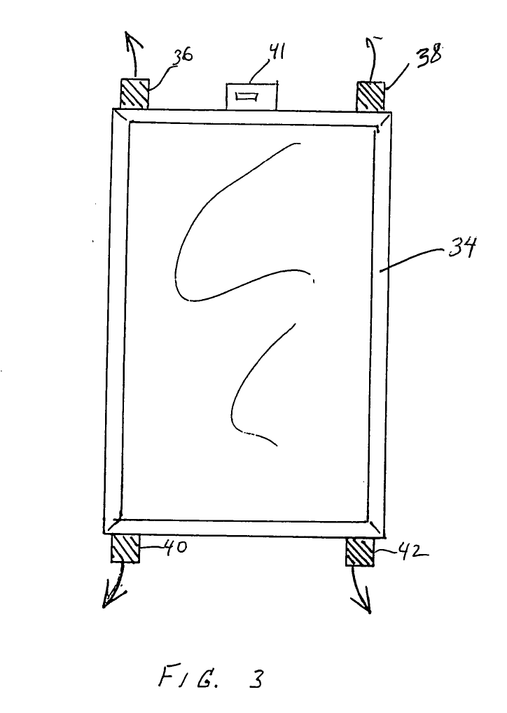

FIG. 1 illustrates a preferred embodiment of the present invention showing the article 10 of the present invention used with a double-faced tape for the purpose of precisely attaching an object such as a picture frame (see FIG. 3) to a surface, such as a wall. A first release film 12 comprises sections 14, 16 and 19. An approximately 180 degree fold at 21 allows section 19 to be provided below section 14. An adhesive layer 18 is provided between section 19 of the first release film 12 and a second release film 20. Section 16 projects beyond the adhesive layer 18 in the form of a tab and would facilitate the easy removal of the first release film 12 once the object is properly positioned on the surface to which it will adhere.

The type of article 10 shown in FIG. 1 could be used to secure a picture frame 34 to a wall (See FIG. 3). In this instance, each of the articles 10 would be applied to the four corners of the picture frame in a manner allowing projection tabs 36, 38, 40 and 42 to extend both beyond the adhesive layer shown in FIG. 1 as well as beyond the edges of the picture frame 34. Initially, the second release film 20 is removed from the article 10 and the adhesive layer 18 would allow the article 10 to be attached to the rear surface of the picture frame adjacent to the corners of the picture frame as shown in FIG. 3. A standard type level 41 is removably secured to the top of the picture frame using a weak adhesive. Once the picture frame is in the correct location on a wall and is properly aligned using the level 41, the picture frame is pressed against the wall and each of the projection tabs 36, 38, 40 and 42 (corresponding to the projection tab 16 shown in FIG. 1) is pulled in the direction shown by the arrows, the release film would be removed allowing the adhesive layer initially abutting the second release film 20 to be pressed against the wall, thereby properly affixing the picture frame 34 thereto. The level 41 is then removed from the top of the picture frame.

The embodiment shown in FIGS. 1 and 3 utilizes a first release film 12 and a second release film 20, thereby allowing the consumer to physically place the article 10 onto the picture frame, or similar device, directly. Another variation of this embodiment would be to have the article 10 directly applied to the picture frame at the factory. Therefore, in this embodiment, the second release film 20 would not be necessary.

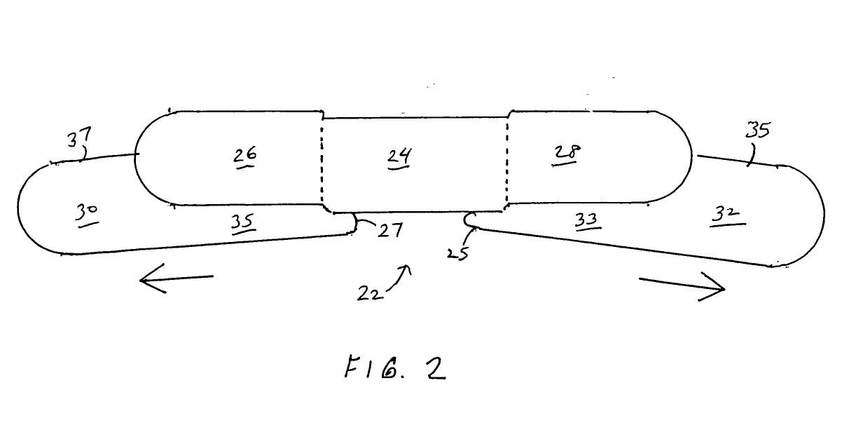

A second preferred embodiment is shown in FIG. 2 for use with a medical bandage 22. The bandage would normally include a single non-adhesive absorbent section 24 to be placed directly over a wound on the human body. This section 24 is provided between two single faced adhesive sections 26 and 28. A first release film 35 is provided directly under one of the adhesive sections 28. Similar to the embodiment shown in FIG. 1, a portion 33 of the release film 32 is provided directly under the adhesive of section 28 and is adhered thereto. A second portion 35 of the first release film 32 extends as a tab beyond the adhesive section 28. As is shown in the embodiment depicted in FIG. 1, the first release film 35 is folded back over itself as a 180° fold at 25 which adheres to the adhesive portion of section 28. Similarly, a second release film 30 is folded back over itself at 27 such that a portion 35 adheres to the adhesive layer of the adhesive section 26. A second section 37 of the release film 30 projects as a tab beyond the adhesive section 26. Therefore, in use, section 24 is placed over a wound. Pressure is applied to the bandage 22 as each of the release films 30 and 32 is removed by pulling on its respective tabs 37, 35 in the direction shown by the arrows, thereby easily and accurately securing the section 24 over the wound.

The embodiment illustrated in FIG. 2 would permit a bandage to be placed exactly on the portion of the skin to be protected without wrinkling or deforming either the skin or the bandage 22. Additionally, the utilization of the projection pads 35 and 37 would allow the bandage to be applied to the skin without forcing an individual to touch the bottom adhesive layers of sections 26 and 28, thereby insuring a more sanitary application to the skin. Normally, when a bandage is applied to the skin, the user or one applying the bandage would touch the adhesive surfaces during the time that the release films are removed but before they are applied to the user's skin. Therefore, any contaminants on the person's fingers can transfer to the skin of the person to whom the bandage 22 is applied.

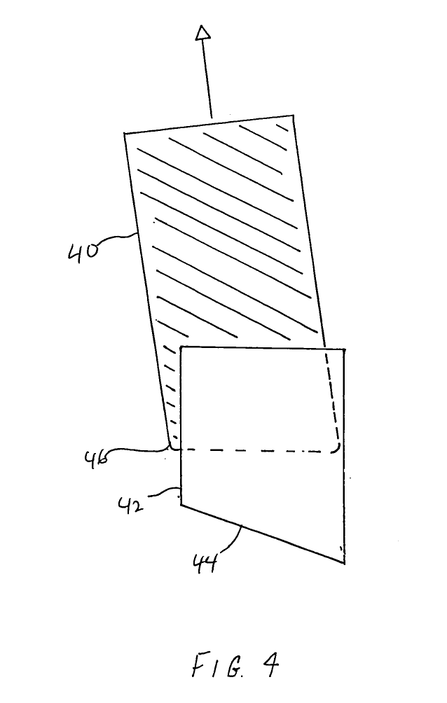

FIG. 4 illustrates an additional feature of the present invention allowing reduced resistance to the removal of the release film 40 from an adhesive layer 42. The end of the adhesive section 42 is angled as shown at 44. Prior to the release film 40 being removed in the direction as shown by the arrow in FIG. 4, only a portion of the end of the release film 40 would be attached to the adhesive 42. Therefore, a small section of the end 46 of the release film 40 would extend over the angled end line 44 thereby resulting in reduced resistence to the removal of the released film 40.

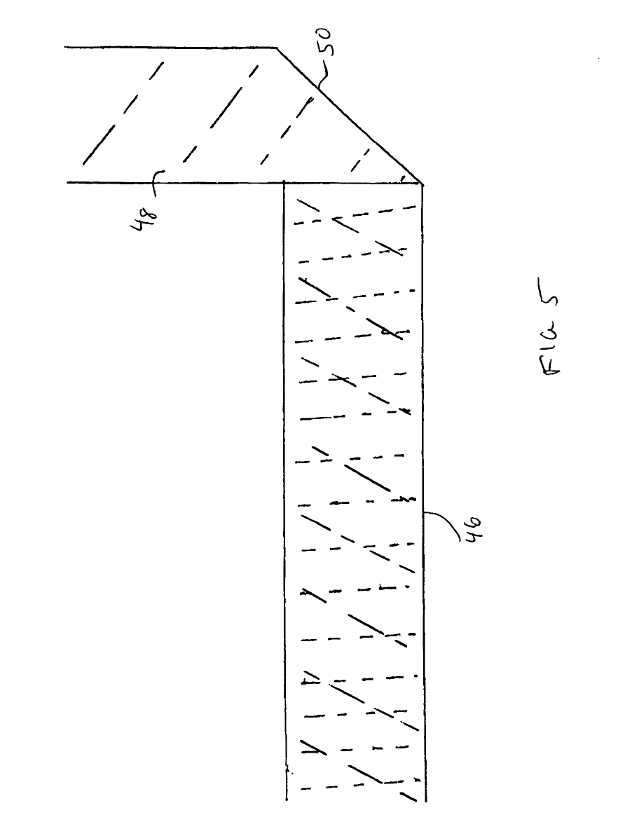

The present invention could be utilized to apply signs or letters and numbers to any surface. House numbers and mailboxes are typical sites for this application. If the letters or numbers are not rigid, but are made of thin, pliable plastic film, or paper, then the crease in the release film is positioned just far enough inwardly from one edge of the letter to allow that edge to be held in place by finger as the release film is pealed back across itself, and away from the attaching surface. The single faced and double faced adhesive strip embodiments shown in FIGS. 1-4 illustrate a release film folded back 180° upon itself. It should be noted that the release strip could be folded back at an angle less than 180° depending upon the specific application. For example, while the embodiment shown in FIG. 3 described an application to a picture frame utilizing a 180° fold, this fold could be as little as 90° as shown with respect to FIG. 5 illustrating a release film 40 attached to a carpet tape 46 by a 90° fold shown at 50.

It is important to note that the exact type of adhesive used to attach the article to an object and to another surface such as human skin or a wall is unimportant. Based upon the type of object employed or the surface to which the object is to be attached, various types and strengths of adhesives could be employed.

It is clear to one possessing ordinary skill in the art from the description of the present invention that the application of the article to a bandage, a sign, a picture frame and a carpet tape merely serves as an example of the type of object to which the article can be applied. More particularly, embodiments of the invention have been described, it is not intended that the invention be limited thereto, as it is intended that the invention be as broad in scope as the art will allow and that the specification be read in a like manner. It will be therefore appreciated by those skilled in the art that yet other modifications and embodiments could be made to the invention without deviating from its spirit and scope.

What is claimed is:

1. An article attached to an object, allowing the object to be affixed to a surface, comprising:
an adhesive layer; and
a first release film removably attached to said adhesive layer, said first release film including a first section removably attached to a first side of said adhesive layer and a second section attached to and folded with respect to said first section;
wherein said first release film is separated from the article by pulling said second section of said first release film as the article is pressed against the surface until said first release film is completely removed from the article, thereby actively positioning the object on the surface.

2. The article in accordance with claim 1, wherein said first section is folded approximately 90° with respect to said second section.

3. The article in accordance with claim 1, wherein said first section of said first release film is folded upon itself at angle of approximately 180° with respect to said second section, said second section provided on top of said first section, said second section including a tab section extending beyond said adhesive layer.

4. The article in accordance with claim 1, further including a second release film attached to a second side of said adhesive layer.

5. The article in accordance with claim 1, further including a second release film attached to a second side of said adhesive layer.

6. The article in accordance with claim 4, wherein the end of said adhesive layer is angled with respect to said first section of said first release film thereby resulting in reduced resistance upon removal of said first release film.

7. An article for attaching an object to a surface, comprising:
an adhesive layer;
a first release film removably attached to said adhesive layer, said first release film including a first section removably attached to a first side of said adhesive layer and a second section attached to and folded with respect to said first section, said first release film and said adhesive layer constituting the article;
an object permanently attached to said adhesive layer of said article;
wherein said first release film is separated from said article by pulling said second section of said first release film as said article is pressed against the surface until said first release film is completely removed from said article, thereby accurately positioning said object on said surface.

8. The article in accordance with claim 7, wherein said first section is folded approximately 90° with respect to said second section.

9. The article in accordance with claim 7, wherein said first section of said first release film folded upon itself at angle of approximately 180° with respect to said second section, said second section provided on top of said first section, said second section including a tab section extending beyond said adhesive layer.

10. The article in accordance with claim 7, further including a second release film attached to a second side of said adhesive layer.

11. The article in accordance with claim 9, further including a second release film attached to a second side of said adhesive layer.

12. The article in accordance with claim 7, wherein said object is a bandage.

13. The article in accordance with claim 9, wherein said object is a bandage.

14. The article in accordance with claim 7, wherein said object is a carpet.

15. The article in accordance with claim 7, wherein said object is a sign.
